(19) United States
(12) Patent Application Publication
(10) Pub. No.: US 2014/0098657 A1
(43) Pub. Date: Apr. 10, 2014

(54) Error Recovery

(71) Applicant: Reneses Mobile Corporation, Tokyo (JP)

(72) Inventors: Keiichi KUBOTA, Weybridge (GB); Brian MARTIN, Farnham (GB)

(73) Assignee: Reneses Mobile Corporation, Tokyo (JP)

(21) Appl. No.: 14/049,465

(22) Filed: Oct. 9, 2013

(30) Foreign Application Priority Data
Oct. 9, 2012 (GB) 1218091.5

(51) Int. Cl. H04W 24/02

(52) U.S. Cl. CPC H04W 24/02
USPC 370/216

(57) ABSTRACT

Measures for use in recovering from ciphering errors in an unacknowledged mode environment. The measures, including methods, apparatus, and computer program products, may utilize a user equipment (UE), such as a mobile terminal, to communicate with a network node, such as a wireless station. The network node may mark Radio Bearers (RBs) communicating in the UM RLC mode to manage re-establishment of RBs in response to a ciphering error. In the event of a ciphering error in communications between the UE and the network node, the network node may cause a radio link failure. The radio link failure may cause the UE to initiate a cell update. In response to the cell update, the network node and the UE may each re-establish marked RBs, thus reinitializing the cipher values and correcting the error.

### CROSS REFERENCE TO RELATED APPLICATION

This application claims benefit under 35 U.S.C. §119(a) and 37 CFR 1.55 to UK patent application no. GB1218091.5, filed on 9 Oct. 2012, the entire content of which is hereby incorporated by reference.

### TECHNICAL FIELD

The present disclosure relates generally to wireless communications, and, more particularly, to management of ciphering errors during wireless communications.

### BACKGROUND

It is increasingly common for smart phones, laptops, and other devices to contain communications interfaces that are capable of interacting with wireless data services such as 3G, WiMAX, and Long Term Evolution networks. Proliferation of these devices has also lead to development of novel applications and usage patterns that leverages the “always on” nature of the wireless data networks. As these devices become more powerful and approach the capabilities of personal computers, it has become possible for data transmission techniques that were designed and refined for communication among networked computers to be applied to the increased ranges of the wireless communication realm. One such method involves associating a particular User Equipment (UE), such as a mobile terminal, with an Internet Protocol (IP) address, and using the IP address to route voice traffic.

One method that is being explored for providing voice traffic in this way is the use of an Unacknowledged Mode (UM) for transmitting the data. Radio Bearers (RBs) that are configured to use UM Radio Link Control (UM RLC) may transmit and receive data independent from acknowledgement of the data from the receiver and transmitter, respectively. Such communication is usefiu for streaming data such as voice or video data, as, in the case of voice data, there is no need to transmit dropped data packets if subsequent data packets have been received and played to the user (e.g., if there is a short gap in a voice communication, there is little point in filling in the gap after the user has already continued the conversation).

In order to enable UM RLC transmission and reception, one or more Radio Bearers (RBs) may be configured by the network to communicate between the network and the UE. In order to preserve privacy and security of user data transmitted on a public wireless channel, data communications using the RBs may be encrypted using a cipher value. This cipher value may be known to both the UE and the network, and the cipher value may be dynamically updated as data is transmitted to provide increased data security. However, since the UE and the network may maintain the cipher independently, it may be possible for the cipher value to become out of sync in the event the UE and network fail to update the cipher at the same rate.

One possible circumstance that may lead to unsynchronized cipher values involves packet loss in communications between the UE and the network. In the event that the UE fails to receive more than a certain number of packets (e.g., more than 128 packets), the cipher value may wrap around, causing ciphering errors in data transmitted by the RB experiencing the wrap around.

In the case of acknowledged transmissions, unrecoverable error states may be detected and corrected due to a lack of acknowledgements from a receiving entity. In response to the unrecoverable error state, the transmitting entity may reestablish the connection to correct the error. In some cases, the packet loss may also last long enough to cause a failure of the radio link, thus causing reestablishment of the connection and thus, the ciphering process. However, in the case of UM RBs, an unrecoverable error may not be detected due to the lack of acknowledgement messages. For example, if the cipher value becomes unsynchronized but the packet loss does not last long enough to ensure a reset of the RB, then the ciphering errors may persist since the packet loss does not cause a reset of the RB and thus reset the cipher value. For example, where a communication protocol specifies 128 cipher sequence values and a radio link failure timer of 5 seconds, the connection may experience cipher errors after 2.56 seconds, such that if the network and UE regain synchronization between 2.56 and 5 seconds, cipher errors will occur with no method for the RBs operating in UM to re-establish communication between the UE and the network with correct cipher values.

### SUMMARY

In accordance with first embodiments, there is apparatus for use in ciphering error recovery in wireless communications, the apparatus comprising at least one processor, and at least one memory including computer program code, the at least one memory and the computer program code being configured to, with the at least one processor, cause the apparatus at least to:

establish communications using an unacknowledged mode channel;

detect a ciphering error on data communicated via the unacknowledged mode channel;

in response to detecting the ciphering error, cause a failure, the failure causing initiation of a cell update procedure;

in response to the failure, receive a cell update message; and

in response to receipt of the cell update message, reestablish the unacknowledged mode channel.

In accordance with second embodiments, there is a method for use in ciphering error recovery in wireless communications, the method comprising:

establishing communications using an unacknowledged mode channel;

detecting a ciphering error on data communicated via the unacknowledged mode channel;

in response to detecting the ciphering error, causing a failure, wherein the failure causes initiation of a cell update procedure;

in response to the failure, receiving a cell update message; and

in response to receipt of the cell update message, reestablishing the unacknowledged mode channel.

In accordance with third embodiments, there is a computer program product comprising a non-transitory computer-readable storage medium having computer readable instructions stored thereon, the computer readable instructions being executable by a computerized device to cause the computerized device to perform a method for use in ciphering error recovery in wireless communications, the method comprising:

establishing communications using an unacknowledged mode channel;

detecting a ciphering error on data communicated via the unacknowledged mode channel;

in response to detecting the ciphering error, causing a failure, wherein the failure causes initiation of a cell update procedure;

in response to the failure, receiving a cell update message; and

in response to receipt of the cell update message, reestablishing the unacknowledged mode channel.

In accordance with fourth embodiments, there is apparatus for use in unacknowledged mode communications, the apparatus comprising at least one processor, and at least one memory including computer program code, the at least one memory and the computer program code being configured to, with the at least one processor, cause the apparatus at least to:

perform a cell update procedure in response to a communications failure;

in response to performance of the cell update procedure, determine if one or more unacknowledged mode channels are configured with a particular configuration value; and

in response to determining that the one or more unacknowledged mode channels are configured with the particular configuration value, reestablish the one or more unacknowledged mode channels.

In accordance with fifth embodiments, there is a method for use in unacknowledged mode communication, the method comprising:

performing a cell update procedure in response to a communications failure;

in response to performance of the cell update procedure, determining if one or more unacknowledged mode channels are configured with a particular configuration value; and

in response to determining that the one or more unacknowledged mode channels are configured with the particular configuration value, reestablishing the one or more unacknowledged mode channels.

In accordance with sixth embodiments, there is a computer program product comprising a non-transitory computer-readable storage medium having computer readable instructions stored thereon, the computer readable instructions being executable by a computerized device to cause the computerized device to perform a method for use in unacknowledged mode communications, the method comprising:

performing a cell update procedure in response to a communications failure;

in response to performance of the cell update procedure, determining if one or more unacknowledged mode channels are configured with a particular configuration value; and

in response to determining that the one or more unacknowledged mode channels are configured with the particular configuration value, reestablishing the one or more unacknowledged mode channels.

Further features of embodiments will become apparent from the following description of embodiments, given by way of example only, which is made with reference to the accompanying drawings.

### BRIEF DESCRIPTION OF DRAWINGS

Having thus described certain embodiments in general terms, reference will now be made to the accompanying drawings, which are not necessarily drawn to scale, and wherein:

FIG. 1 is a block diagram of an apparatus that may be specifically configured in accordance with an example embodiment of the present disclosure;

FIG. 2 is a schematic diagram of an example mobile terminal in communication with a network node in accordance with an example embodiment of the present disclosure;

FIG. 3 is a block diagram of an example messaging timeline in an unacknowledged messaging environment in accordance with an example embodiment of the present disclosure;

FIG. 4 is a signaling diagram of a message flow between a UE and a network node to recover from a ciphering error in accordance with an example embodiment of the present disclosure;

FIG. 5 is a flow diagram depicting an example of a method for recovering from a ciphering error performed by a network node in accordance with an example embodiment of the present disclosure; and

FIG. 6 is a flow diagram depicting an example of a method for recovering from a ciphering error performed by a user equipment in accordance with an example embodiment of the present disclosure.

### DETAILED DESCRIPTION

Embodiments of the present disclosure will now be described more fully hereinafter with reference to the accompanying drawings, in which some, but not all, embodiments are shown. Indeed, various embodiments may be embodied in many different forms and should not be construed as limited to the embodiments set forth herein. Like reference numerals refer to like elements throughout. As used herein, the terms “data,” “content.” “information.” and similar terms may be used interchangeably to refer to data capable of being transmitted, received and/or stored in accordance with embodiments of the present disclosure. Thus, use of any such terms should not be taken to limit the scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium.” which refers to an electromagnetic signal.

A method, apparatus and computer program product are provided in accordance with an example embodiment of the present disclosure in order to manage recovery from cipher errors when using an unacknowledged data transmission method. The term unacknowledged data protocol is generally understood to relate to data transfer protocols that allow transmission of data packets without acknowledgement of the packets by the receiver. Some examples of such unacknowledged data transmission formats include UM RLC or User Datagram Protocol (UDP). A method, apparatus and computer program product of an example embodiment may operate to enable communications between a UE and a network node. During establishment of an unacknowledged data transfer format, the network node may mark a radio bearer associated with the unacknowledged data transfer format. When packet loss between the UE and the network node results in cipher errors, the network node may cause a radio link failure. In response to the radio link failure, the UE may initiate a cell update process. During the cell update process, the network node and/or UE, may each reestablish marked radio bearers, thus fixing the ciphering errors for those radio bearers without requiring a Radio Resource Control (RRC) reconfiguration message. Reestablishing the marked radio bearers may include actions such as resetting state variables, initializing a ciphering counter, and flushing buffered data. An example of a reestablishing process is provided in a Third Generation Partnership Project (3GPP) Technical Standard 25.322, sub clause 9.7.7.

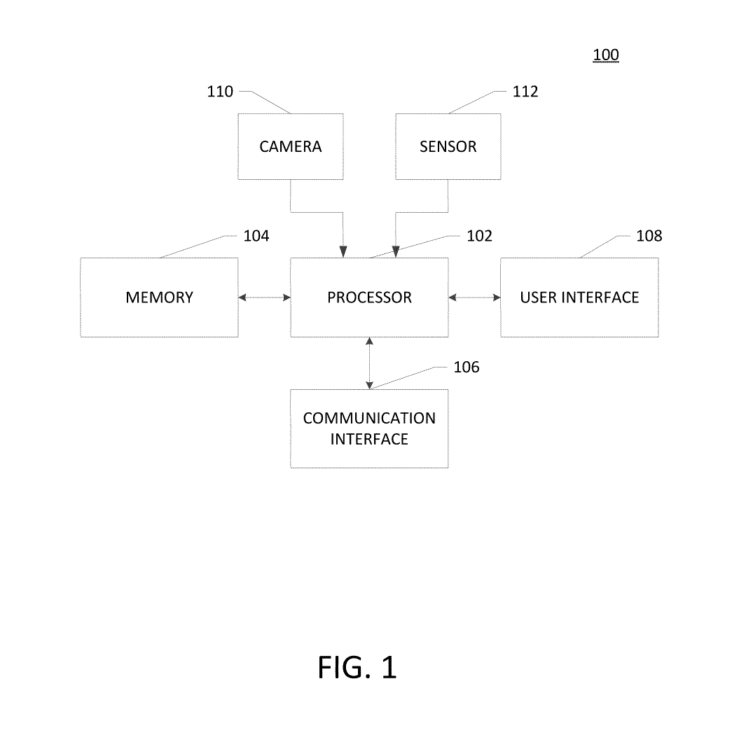

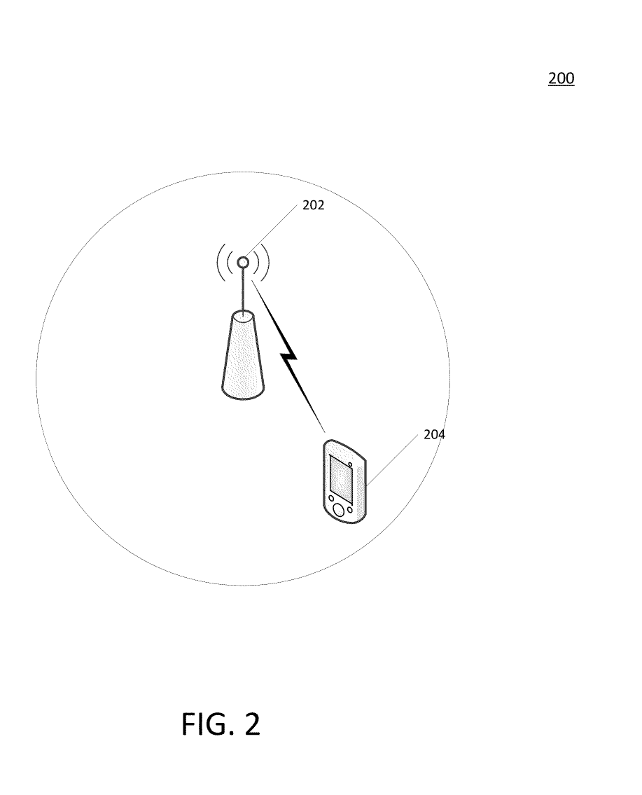

The system of an embodiment of the present disclosure may include an apparatus 100 as generally described below in conjunction with FIG. 1 for performing one or more of the operations set forth by FIGS. 2-6 and also described below. The apparatus will be described in terms of a UE or a network node for the purposes of example, but the apparatus 100 may also be embodied in another type of computing device, either mobile or fixed, such as a computer workstation, a personal computer, a laptop, a cellular phone, or a smart phone. In this embodiment, the apparatus 100 may be in communication with a display and/or a data network, either directly, such as via a wireless or wireline connection, or indirectly via one or more intermediate computing devices. The display and the apparatus 100 may be parts of the same system in some embodiments. However, the apparatus 100 may alternatively be embodied by another computing device that is in communication with the display and the mobile terminal, such as via a wireless connection, a wireline connection or the like. For example, the apparatus may be a mobile telephone, a personal digital assistant (PDA), a pager, a laptop computer, a tablet computer, a data card, a USB dongle, a cellular modem, a cellular base tower, an enhanced Node B (eNB), or any of numerous other hand held or portable communication devices, computation devices, content generation devices, content consumption devices or combinations thereof.

It should also be noted that while FIG. 1 illustrates one example of a configuration of an apparatus 100 for correcting ciphering errors, numerous other configurations may also be used to implement other embodiments of the present disclosure. As such, in some embodiments, although devices or elements are shown as being in communication with each other, hereinafter such devices or elements should be considered to be capable of being embodied within the same device or element and thus, devices or elements shown in communication should be understood to be alternatively portions of the same device or element.

Referring now to FIG. 1, the apparatus 100 for correcting ciphering errors in accordance with example embodiments may include or otherwise be in communication with one or more of a processing system and/or processor 102, a memory 104, a communication interface 106, a user interface 108, a camera 110 and a sensor 112. In some embodiments, the processing system and/or processor (and/or co-processors or any other processing circuitry assisting or otherwise associated with the processor) may be in communication with the memory device via a bus for passing information between components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present disclosure. For example, the memory device could be configured to buffer input data for processing by the processor. Additionally or alternatively, the memory device could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 102 (or processing system) may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory device 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present disclosure by further configuration of the processor by instructions for performing the algorithms and/or operations described herein. The processor may include, among other things, a clock, an arithmetic logic unit (ALU) and logic gates configured to support operation of the processor.

The communication interface 106 may be any means such as a device or circuitry embodied in either hardware or a combination of hardware and software that is configured to receive and/or transmit data from/to a network and/or any other device or module in communication with the apparatus 100, such as by supporting communications with a display and/or a mobile terminal. In this regard, the communication interface may include, for example, an antenna (or multiple antennas) and supporting hardware and/or software fir enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. The communication interface 106 may serve to couple the apparatus 100 to a cellular network, such as a network operating according to a 3G, Long Term Evolution, or Long Term Evolution-Advanced protocol.

The apparatus 100 may include a user interface 108 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. In one embodiment, the display of the apparatus may be embodied by a liquid crystal display (LCD) screen presented on one surface of the mobile terminal. The processor 102 may comprise user interface circuitry configured to control at least some functions of one or more user interface elements such as a display and, in some embodiments, a speaker, ringer, microphone and/or the like. The processor 102 and/or user interface circuitry comprising the processor 102 may be configured to control one or more functions of one or more user interface elements through computer program instructions (e.g., software and/or firmware) stored on a memory accessible to the processor (e.g., memory 104, and/or the like).

In some example embodiments, the apparatus 100 may include an image capturing element, such as a camera 110, video and/or audio module, in communication with the processor 102. The image capturing element may be any means for capturing an image, video and/or audio for storage, display or transmission. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while a memory device 104 of the apparatus stores instructions for execution by the processor in the form of software necessary to create a digital image file from a captured image. In an example embodiment, the camera 110 may further include a processing element such as a co-processor which assists the processor in processing image data and an encoder and/or decoder for compressing and/or decompressing image data. The encoder and/or decoder may encode and/or decode according to, for example, a joint photographic experts group JPEG) standard, a moving picture experts group (MPEG) standard, or other format.

As shown in FIG. 1, the apparatus 100 may also include one or more sensors 112, such as a location information receiver (e.g., a GPS receiver), an accelerometer, a gyroscope, a compass, or the like, that may be in communication with the processor 102 and may be configured to determine the location of the apparatus and to detect changes in motion and/or orientation of the apparatus.

The method, apparatus 100 and computer program product may now be described in conjunction with the operations illustrated in FIGS. 2-6. In this regard, the apparatus may include means, such as the processor 102, the communications interface 106, or the like, for correcting ciphering errors. The apparatus 100 may communicate via an unacknowledged data format. During initialization and/or configuration of the unacknowledged data format (e.g., when establishing a connection between the apparatus 100 and another device), a communication channel, such as a RB, may be marked as transmitting and/or receiving via an unacknowledged format. In the event ciphering errors are detected on the communication channel, the processor 102 may, where the apparatus functions as a network node, cause a failure on the communication channel. The failure may cause an update operation to be performed on the channel, and the apparatus may reestablish the communication channel during the update operation.

In cases where the apparatus 100 functions as a UE, the processor 102 may receive an indication that the communication channel is operating in an unacknowledged mode during initial configuration of the channel. In the event of a failure of the communication channel, the processor 102 may cause an update operation to be performed on the channel, such as a cell update. During the cell update, the processor 102 may reestablish communication for each of the marked channels.

FIG. 2 is a schematic diagram of an example mobile terminal in communication with a wireless station in accordance with an example embodiment of the present disclosure. FIG. 2 depicts a wireless network 200 including a network node 202 in communication with a UE 204. The wireless network 200 may represent a single “cell” of a cellular network operated by a cellular provider. The network node 202 may be a tower or set of towers for providing coverage to the cell of the network. The wireless network 200 may be provided according to one or more wireless protocols, such as 3G or Long Term Evolution. Examples of network nodes may include, but are not limited to, 3G “Node B” or “Radio Network Controller” nodes, or Long Term Evolution “Enhanced Node B” (eNodeB) nodes. As described above, the UE 204 may be any type of mobile terminal, laptop, desktop, cellular modem, data card. USB dongle, or computing device capable of wireless communication with the network node 202.

The UE 204 and the network node 202 may communicate data over various frequencies of the spectrum. Communications may be enabled between these devices according to various scheduling methods, such as time division multiple access (TDMA) or code division multiple access (CDMA). Communications between the network node 202 and UE 204 may be encrypted according to a cipher. The cipher may include a plurality of values in sequence, such that each packet is encrypted with a different value. The network node 202 and the UE 204 may synchronize the values in sequence to ensure that each uses the appropriate cipher to encrypt/decrypt the data as it is transmitted/received, respectively. If the cipher values become out of synchronization, the one device may attempt to decrypt data according to the wrong value, resulting in a ciphering error. Such ciphering errors must be detected and corrected to ensure that the receiving device can properly decrypt received data.

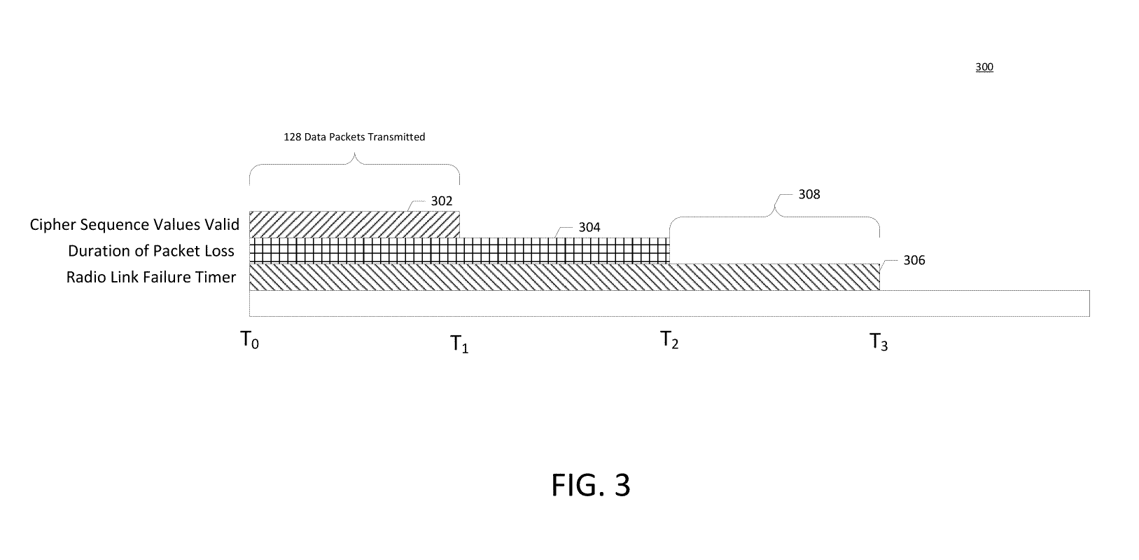

In circumstances where packet loss occurs between the network node 202 and the UE 204, it may be possible for more than the number of packets corresponding to the number of cipher values to be missed by a receiver. In such circumstances, the receiving device corrects the cipher problem, such as by reestablishing the communication channel, in order to recover the ability to properly receive data from the transmitter. Example embodiments thus provide a method for correcting such ciphering errors without the need for explicit reconfiguration messaging. An example method for correcting such ciphering errors in an unacknowledged messaging environment is described further below with respect to FIGS. 3-6.

FIG. 3 is a block diagram of an example messaging timeline 300 in an unacknowledged messaging environment in accordance with an example embodiment of the present disclosure. The messaging timeline 300 depicts how ciphering error may occur in an unacknowledged message environment. At time T₀ depicted in the timeline, packet loss 304 begins to occur between two devices communicating using an unacknowledged messaging protocol with synchronized ciphering sequence values for data encryption. For example, the two devices may be a UE and a network node, as described with respect to FIG. 2. For a period of time 302 from T₀ to T₁, the ciphering sequence values may remain synchronized, such that if the connection recovers during the period of time 302, no ciphering error will occur. This time period defines a time period in which the transmitting entity has transmitted a number of data packets greater than the number of sequence values available to manage the ciphering process. For example, the data transfer protocol may use a 7 bit sequence value, specifying a total of 128 sequence values. Thus, transmission of 128 or more messages may result in a wraparound of the sequence value. The sequence value may define a relationship to one or more ciphering parameters. The ciphering parameters may include values or definitions that allow the UE and the network node to encrypt and decrypt communications with one another. For example, the ciphering parameters may include a hyper frame number (HFN), which functions as part of a ciphering counter to ensure synchronization between the transmitter and the receiver. The ciphering parameter may be initialized to a common value known to the transmitter and the receiver. This common value may be used to cipher and decipher data transmissions between these entities. As data packets are transmitted and received, each side may increment the ciphering counter to modify the ciphering parameter, while also ensuring synchronization between the sender and receiver.

Each time the transmitting side sends a packet, it may increment the sequence value, thus adjusting the ciphering parameters in relation to the known common value. Every time the receiving time receives a packet, the receiver may update the ciphering parameter to the value specified by the sequence number of the received packet. When the sequence wraps around, the sender and receiver may begin using a new ciphering parameter value (e.g., every 128 messages, the sender and receiver may begin using a new HFN). However, if the receiver begins to fail to receive packets, the sender may be incrementing the sequence value while the receiver does not. In cases where the connection recovers and the receiver begins receiving again, if the sequence value of the newly received packet is greater than the last received packet but the ciphering parameter has not changed, then the receiver may continue to receive the data. If the sequence value of the newly received packet is less than the last received packet, then the receiver may deduce that a wrap-around of sequence values has occurred and a new ciphering parameter should be used. However, where the sequence value of the newly received packet is greater than the sequence value of the last received packet and a wraparound has occurred at the transmitter, the receiver may have no way to identify that a new ciphering parameter value is needed.

If the packet loss duration is long enough that the sequence value wraps around on the transmitter (e.g., by incrementing the sequence value every time a data packet is sent) but the receiving entity misses the wrap around, a ciphering error may occur. For example, if the receiving entity misses 128 consecutive data packets, and then receives a data packet which has a greater sequence number than the last received sequence number, the receiving entity may fail to note the wrap around and thus begin to experience ciphering errors. In the instant example timeline 300, the packet loss 304 may end at time T₂. However, a radio link failure timer 306 may not expire until time T₃. Expiration of the radio link failure timer 306 may cause the transmitting entity to stop data transmissions, which could stop the transmitting entity from incrementing the cipher sequence value, preventing the error if the timer expires while the sequence value still provides valid ciphering values. However, in the instant example, the timer does not expire before the minimum number of messages have been missed to result in an invalid sequence (and thus ciphering) value.

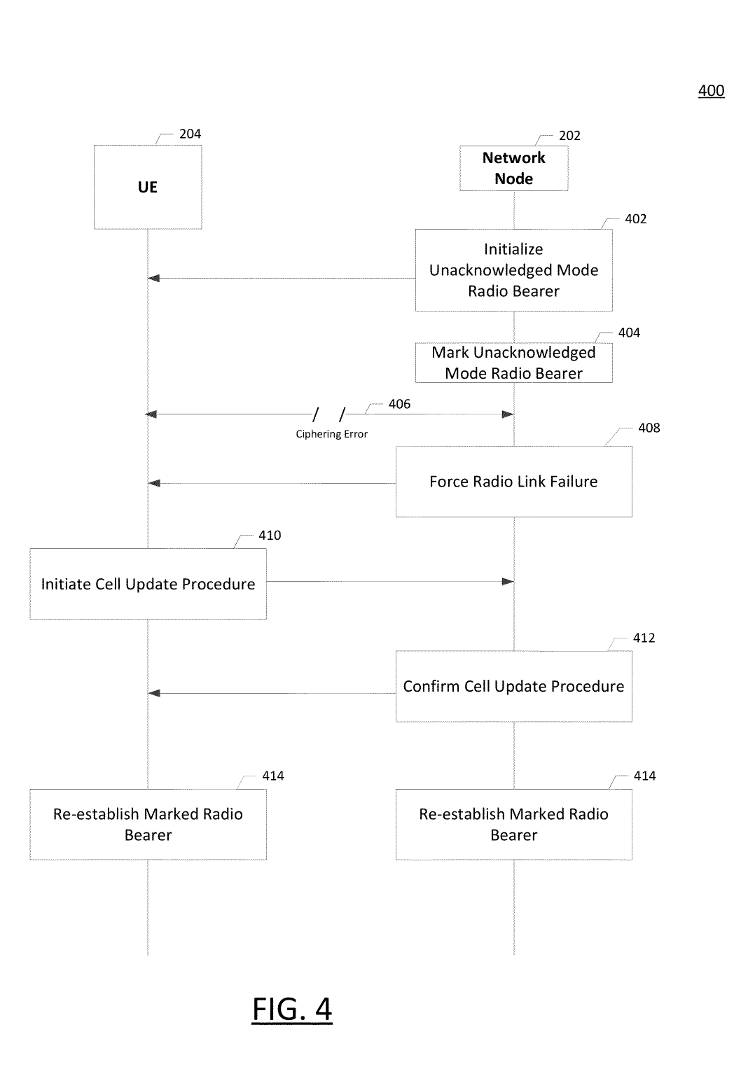

As such, the receiving device may experience cipher errors at any time during the time period 308, where the packet loss has ended, the cipher sequence value has wrapped around without knowledge of the receiving device, and the radio failure timer 306 has not yet expired. Since, in the instant example, the connection recovers during the time period 308, which is prior to the expiration of the radio link failure timer 306, the connection may not perform reset operations that would otherwise correct the cipher error. As such, in response to detection of a cipher error (e.g., one or more data packets failing to decrypt properly), the receiving device may perform actions that alleviate the cipher error. Such actions are described further below with respect to FIGS. 4-6.

FIG. 4 is a signaling diagram of a message flow 400 between a UE and a network node to recover from a ciphering error in accordance with an example embodiment of the present disclosure. The message flow 400 depicts communications between two devices, such as a UE 204 and a network node 202, in communication via an unacknowledged messaging protocol, such as UM RLC. The message flow 400 depicts the process by which a communication channel, such as a RB, may be initialized and/or configured such that, in response to a radio link failure, the communication channel is reestablished during a cell update process.

At action 402, an unacknowledged messaging channel is established between the UE 204 and the network node 202. The unacknowledged data channel may be, for example, a RB configured to send and receive messages according to a UM RLC protocol. Although in some embodiments (such as, for example, UMTS networks), the unacknowledged data channel may be initialized by the network node, other embodiments may provide for initialization of the channel by the UE 204, or by a collaborative process involving both the UE and the network node 202. Initialization of the channel may include configuration of one or more RBs, or reconfiguration of an existing RB.

At action 404, the channel initialized at action 402 is marked as relating to an unacknowledged mode channel. For example, the channel (e.g., a RB), may be associated with a set of setup or configuration information (e.g., a set of radio access bearer information for setting up the channel), and the setup or configuration information may have a flag set or another data value, indicating that the channel is configured for recovery from cipher error conditions in an unacknowledged messaging format. In some embodiments, the marker may be an information element (IE) associated with configuration of an RB). For example, of the IE is set to a TRUE value, then the RB may be configured to recover from cipher errors as described herein. The marker may, for example, cause the UE 204 or the network node 202 to reestablish the channel in response to a cell update procedure.

At action 406, a ciphering error occurs in communications between the UE 204 and the network node 202. As described with respect to FIG. 3, the ciphering error may occur if packet loss occurs on the communication channel that is sufficient to invalidate the cipher sequence value, but not long enough to trigger a radio link failure timer. The cipher error may result in data being improperly deciphered by a receiving node. For example, the UE 204 may attempt to use an incorrect cipher value due to the sequence wrap-around issue described above, and decipher encrypted data such that the encrypted data fails a verification process, such as a cyclic redundancy check (CRC) process. A failure of the CRC process (or any other process for verifying deciphered data as employed by the receiving device) alerts the receiving device of the ciphering error.

At action 408, the network node 202 may detect the cipher error and force a radio link failure. For example, the network node 202 may cease signaling on a dedicated physical channel (DPCH) associated with the communication channel. Failure of the radio link in this manner may cause the receiving device to initiate a cell update procedure. Various other methods of causing the radio link failure may also be employed.

At action 410, the UE 204 detects the failure of the radio link and initiates a cell update procedure. The cell update procedure may be default processing for the UE 204 in response to the radio link failure. The UE 204 may signal the network node 202 of the cell update procedure. At action 412, the network node may confirm the cell update procedure. The cell update procedure may include release of dedicated physical resources, changing the state of the UE 204 from a dedicated channel state to a common channel state, selecting a best quality cell, and sending a cell update message to the network node 202.

At action 414, the network node 202 and the UI 204 reestablish the marked communication channels. Reestablishing these channels corrects the cipher errors by ensuring that the UE 204 and network node 202 resynchronize the cipher process. In this manner, only marked RBs (e.g., the RBs that are associated with IMS voice service) may be reestablished, resulting in a minimum of disruption to other elements of the network node 202 and the UE 204. The signaling also allows for the use of the cell update procedure to reestablish the channel, without the need for an RRC reconfiguration message.

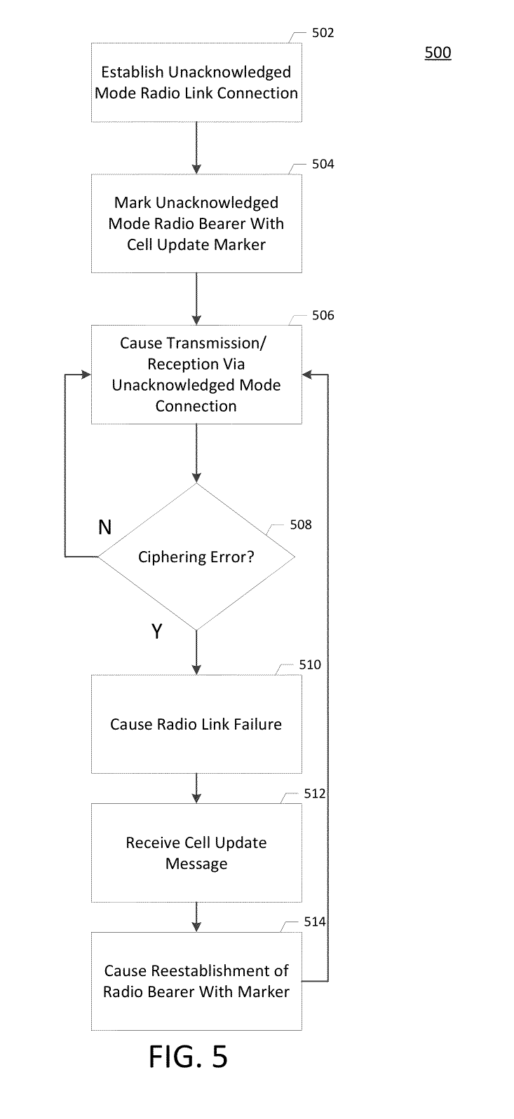

FIG. 5 is a flow diagram depicting an example of a method 500 for recovering from a ciphering error performed by a network node in accordance with an example embodiment of the present disclosure. As described above, a network node 202 may recover from a cipher error by marking one or more RBs as related to an unacknowledged data transfer protocol, causing a radio link failure in response to detection of a ciphering error, and performing a cell update of marked RBs in response to causing the radio link failure. The method 500 may be performed by a processing means, such as a processor 102 configured in operation with an apparatus 100, where the apparatus functions as a network node 202.

At action 502, an unacknowledged mode connection, such as a RB configured according to a UM RLC protocol, is established, such as between the network node 202 and the UE 204. As described above, the connection may be allocated, initialized, and/or configured by the network node 202 according to the standards and guidelines established for 3^{rd} Generation (3G) networks (e.g., Universal Mobile Telecommunications System (UMTS)) or Long Term Evolution networks. The unacknowledged mode connection may established by a processing means, such as the processor 102.

At action 504, the unacknowledged mode connection (e.g., the RB), is marked to be reestablished in the event of a cell update. As described above, the marker may take the form of an entry in a configuration or initialization file or parameters. For example, the marker may be an IE contained within a set of RB information. The connection may be marked by a processing means, such as the processor 102.

At action 506, the method 500 causes transmission and/or reception via the unacknowledged mode connection established at action 502. As described above, various types of data may be transmitted and received via this channel. For example, in some embodiments voice data may be transmitted and received across the channel according to various protocols, such as Internet Protocol Media Subsystem (IMS) voice. Transmission and reception may be caused on the communication channel by a processing means, such as the processor 102.

At action 508, the method 500 determines whether a ciphering error has occurred. As described with respect to FIG. 4, the ciphering error may be determined by deciphering received data, or the network node may predict when a ciphering error has occurred or is likely to occur by monitoring data transmissions. For example, if a network node detects unsuccessful data packet delivery for a consecutive number of packets greater than the maximum sequence value (e.g., 128 consecutive packets for a 7 bit sequence value), then the network node may predict that the receiving device will suffer from a deciphering error. If the received data fails a verification process, such as a CRC check, then a ciphering error may be identified. The ciphering error may result from a process as described with respect to FIG. 3, where packet loss occurs that causes invalidation of a cipher sequence value, but for an insufficient duration to cause failure of the radio link. If a ciphering error has occurred, the method 500 proceeds to action 510. Otherwise, the method 500 returns to action 508 to continue causing transmission and reception of data. The ciphering error may be identified by a processing means, such as the processor 102.

At action 510, the method 500 causes a radio link failure in response to detection of the ciphering error. As described above, the radio link failure may be caused by, for example, stopping signaling on the DPCH. The radio link failure may be caused by a processing means, such as the processor 102.

At action 512, the method 500 receives a cell update message. As described above, the cell update message may be received in response to the radio link failure, as the cell update may be a natural part of the process of recovering from a radio link failure. The cell update message may be caused to be received by a processing means, such as the processor 102.

At action 514, the radio bearer(s) marked at action 504 are caused to be reestablished. In this manner, communication channels (e.g., UM RBs) may be reestablished to correct the ciphering error. After causing reestablishment of the connection, the method 500 returns to action 506 to continue to cause transmission and reception of data. Reestablishment of the RBs may be caused by a processing means, such as the processor 102.

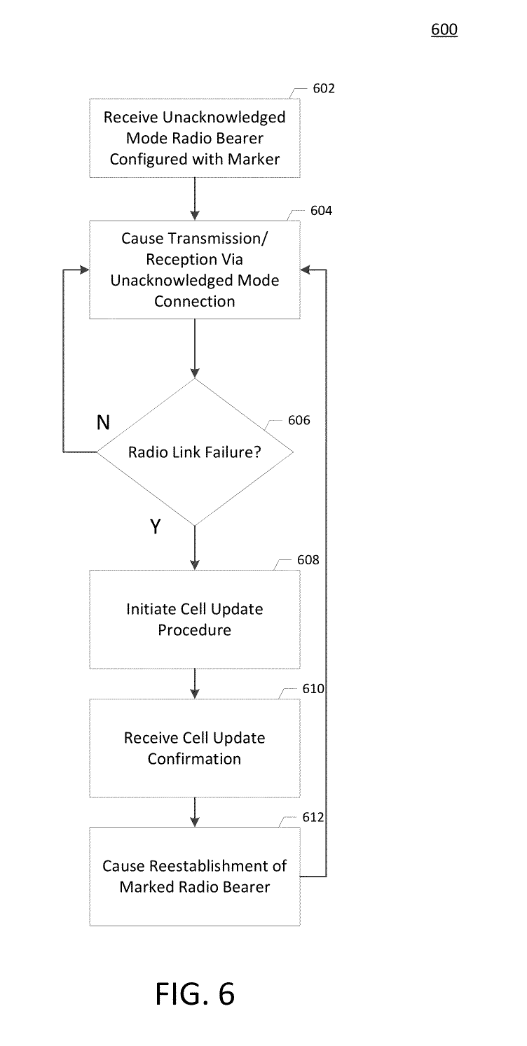

FIG. 6 is a flow diagram depicting an example of a method 600 for recovering from a ciphering error performed by a UE in accordance with an example embodiment of the present disclosure. The method 600 describes the process of recovering from cipher errors from the perspective of the device receiving the data that failed the deciphering process (e.g., the UE). When the network node detects a ciphering error, the network node may cause a failure of the radio link. As such, the UE may detect the radio link failure and initiate a cell update procedure. During the cell update procedure, the UE may reestablish connections (e.g., RBs) that are marked for reestablishment during a cell update procedure.

At action 602, the method 600 receives a configuration for an unacknowledged mode radio bearer that has a marker. As described above, the marker indicates that the marked RB should be reestablished during a cell update operation. Reception of the marked RB may be caused by a processing means, such as the processor 102.

At action 604, transmission and/or reception is caused using the unacknowledged mode connection. Transmission and/or reception may be caused by a processing means, such as the processor 102.

At action 606, the method 600 experiences a radio link failure. As described above with respect to FIGS. 3-5, the radio link failure may be caused by the network (e.g., the network node 202) experiencing a cipher error. If a radio link failure occurs, the method 600 proceeds to action 608. Otherwise, the method 600 continues to cause transmission and reception of data on the unacknowledged mode connection at action 604. The radio link failure may be detected by a processing means, such as the processor 102.

At action 608, the method 600 initiates a cell update procedure in response to detection of the radio link failure. The cell update procedure may be initiated by a processing means, such as the processor 102.

At action 610, the method 600 receives a cell update confirmation in response to initiation of the cell update procedure. For example, the network node 202 may respond to a cell update message generated by a UE 204 with a cell update confirmation. The cell update confirmation may be received via a processing means, such as the processor 102.

At action 612, the method 600 reestablishes the marked RB to fix the ciphering problem by resynchronizing with the receiving device. The RB may be caused to be reestablished by a processing means, such as the processor 102.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present disclosure and executed by a processing system and/or processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Methods, apparatus and computer program products are provided according to example embodiments of the present disclosure in order to recover from ciphering errors in an unacknowledged mode environment. In this regard, the method, apparatus, and computer program product of an example embodiment may utilize a user equipment (UE), such as a mobile terminal, to communicate with a network node, such as a wireless station. The UE and network node may transmit to and receive data from one another via a wireless network. When the UE and network node are configured to communicate via an Unacknowledged Mode (UM) Radio Link Control (RLC) mode, the network node may mark Radio Bearers (RBs) communicating in the UM RLC mode to manage re-establishment of RBs in response in response to a cell update. In the event of a ciphering error in communications between the UE and the network node, the network node may cause a radio link failure. The radio link failure may cause the UE to initiate a cell update. In response to the cell update, the network node and the UE may each re-establish marked RBs, thus reinitializing the cipher values and correcting the error.

Example embodiments may include an apparatus. The apparatus may include means for establishing communications using an unacknowledged mode channel, means for detecting a ciphering error on data communicated via the unacknowledged mode channel, means for, in response to detecting the ciphering error, causing a failure, which causes initiating a cell update procedure, means for receiving a cell update message, and means for, in response to receiving the cell update message, reestablishing the unacknowledged mode channel.

Further example embodiments may include an apparatus. The apparatus may include means for performing a cell update procedure in response to a communications failure, means for, in response to the cell update procedure, determining if one or more unacknowledged mode channels are configured with a particular configuration value, and means for, in response to determining that the one or more unacknowledged mode channels are configured with the particular configuration value, reestablishing the one or more unacknowledged mode channels.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

What is claimed is:

1. Apparatus for use in ciphering error recovery in wireless communications, the apparatus comprising at least one processor, and at least one memory including computer program code, the at least one memory and the computer program code being configured to, with the at least one processor, cause the apparatus at least to:
establish communications using an unacknowledged mode channel;
detect a ciphering error on data communicated via the unacknowledged mode channel;
in response to detecting the ciphering error, cause a failure, the failure causing initiation of a cell update procedure;
in response to the failure, receive a cell update message; and
in response to receipt of the cell update message, reestablish the unacknowledged mode channel.

2. Apparatus according to claim 1, wherein the unacknowledged mode channel comprises a radio bearer.

3. Apparatus according to claim 1, wherein the unacknowledged mode channel communicates according to an Unacknowledged Mode Radio Link Control protocol.

4. Apparatus according to claim 1, wherein the unacknowledged mode channel is configured with a particular configuration value and the at least one memory and the computer program code are configured to, with the at least one processor, cause the apparatus to:
in response to receipt of the cell update message, determine if the unacknowledged channel has the particular configuration value; and
only reestablish the unacknowledged mode channel in response to both the unacknowledged mode channel having the particular configuration value and receipt of the cell update message.

5. Apparatus according to claim 1, wherein the failure comprises a radio link failure.

6. Apparatus according to claim 1, wherein the communications occur according to the Universal Mobile Telecommunications System (UMTS) protocol.

7. Apparatus according to claim 1, wherein the at least one memory and the computer program code are configured to, with the at least one processor, cause the apparatus to respond to the cell update message with a cell update confirm message.

8. Apparatus according to claim 1, wherein the apparatus comprises a user equipment.

9. Apparatus according to claim 8, wherein the user equipment comprises a mobile phone.

10. A method for use in ciphering error recovery in wireless communications, the method comprising:
establishing communications using an unacknowledged mode channel;
detecting a ciphering error on data communicated via the unacknowledged mode channel;
in response to detecting the ciphering error, causing a failure, wherein the failure causes initiation of a cell update procedure;
in response to the failure, receiving a cell update message; and
in response to receipt of the cell update message, reestablishing the unacknowledged mode channel.

11. A computer program product comprising a non-transitory computer-readable storage medium having computer readable instructions stored thereon, the computer readable instructions being executable by a computerized device to cause the computerized device to perform a method for use in ciphering error recovery in wireless communications, the method comprising:
establishing communications using an unacknowledged mode channel;
detecting a ciphering error on data communicated via the unacknowledged mode channel;
in response to detecting the ciphering error, causing a failure, wherein the failure causes initiation of a cell update procedure;
in response to the failure, receiving a cell update message; and
in response to receipt of the cell update message, reestablishing the unacknowledged mode channel.

12. Apparatus for use in unacknowledged mode communications, the apparatus comprising at least one processor, and at least one memory including computer program code, the at least one memory and the computer program code being configured to, with the at least one processor, cause the apparatus at least to:
perform a cell update procedure in response to a communications failure;
in response to performance of the cell update procedure, determine if one or more unacknowledged mode channels are configured with a particular configuration value; and
in response to determining that the one or more unacknowledged mode channels are configured with the particular configuration value, reestablish the one or more unacknowledged mode channels.

13. Apparatus according to claim 12, wherein the unacknowledged mode channel comprises a radio bearer.

14. Apparatus according to claim 12, wherein the unacknowledged mode channel communicates according to an Unacknowledged Mode Radio Link Control protocol.

15. Apparatus according to claim 12, wherein the failure comprises a radio link failure.

16. Apparatus according to claim 12, wherein the communications occur according to the Universal Mobile Telecommunications System (UMTS) protocol.

17. Apparatus according to claim 12, wherein determining if the one or more unacknowledged mode channels are configured with the particular configuration value is performed in response to receipt of a cell update confirm message during the cell update procedure.

18. Apparatus according to claim 12, wherein the apparatus comprises a user equipment.

19. Apparatus according to claim 18, wherein the user equipment comprises a mobile phone.

20. A method for use in unacknowledged mode communication, the method comprising:
performing a cell update procedure in response to a communications failure;
in response to performance of the cell update procedure, determining if one or more unacknowledged mode channels are configured with a particular configuration value; and
in response to determining that the one or more unacknowledged mode channels are configured with the particular configuration value, reestablishing the one or more unacknowledged mode channels.

21. A computer program product comprising a non-transitory computer-readable storage medium having computer readable instructions stored thereon, the computer readable instructions being executable by a computerized device to cause the computerized device to perform a method for use in unacknowledged mode communications, the method comprising:
performing a cell update procedure in response to a communications failure;
in response to performance of the cell update procedure, determining if one or more unacknowledged mode channels are configured with a particular configuration value; and
in response to determining that the one or more unacknowledged mode channels are configured with the particular configuration value, reestablishing the one or more unacknowledged mode channels.
